(19) United States
(12) Patent Application Publication
(10) Pub. No.: US 2025/0142594 A1
(43) Pub. Date: May 1, 2025

(54) INDICATING SIDELINK CHANNEL OCCUPANCY TIME SHARING BETWEEN USER EQUIPMENT

(71) Applicant: Lenovo (Singapore) Pte. Limited, Singapore (SG)

(72) Inventors: Karthikeyan Ganesan, Kronberg Im Taunus (DE); Alexander Golitschek Edler von Elbwart, Darmstadt (DE); Joachim Löhr, Wiesbaden (DE); Prateek Basu Mallick, Dreieich (DE); Vijay Nangia, Woodridge, IL (US); Ravi Kuchibhotla, Chicago, IL (US)

(73) Assignee: Lenovo (Singapore) Pte. Limited, Singapore (SG)

(21) Appl. No.: 18/837,329

(22) PCT Filed: Feb. 5, 2023
(86) PCT No.: PCT/IB2023/051017

§ 371 Date: Aug. 9, 2024

Related U.S. Application Data
(60) Provisional application No. 63/309,226, filed on Feb. 11, 2022.

(51) Int. Cl. H04W 72/25; H04L 5/00

(52) U.S. Cl. CPC H04W 72/25; H04L 5/0094

(57) ABSTRACT

Various aspects of the present disclosure relate to a user equipment (UE) that acquires a channel occupancy time (COT) for part of an unlicensed spectrum, allowing the acquiring UE to transmit sidelink (SL) control and data information to a secondary UE, and furthermore share the COT with the secondary UE. Sharing the COT with the secondary UE allows the secondary UE to transmit SL control and data to the acquiring UE or another UE. To initiate COT sharing, the UE that acquires the COT transmits a COT sharing indicator to one or more destination identifiers (IDs), notifying one or more secondary UEs of the COT sharing. The COT sharing indicator may include any of various information, such as remaining channel occupancy duration, priority, one or more destination IDs, offset indicating when the COT sharing may be transmitted, one or more resource pool IDs, and so forth.

### RELATED APPLICATION

This application claims priority to U.S. Patent Application Ser. No. 63/309,226 filed Feb. 11, 2022 entitled “Indicating Sidelink Channel Occupancy Time Sharing Between User Equipment,” the disclosure of which is incorporated by reference herein in its entirety.

### TECHNICAL FIELD

The present disclosure relates to wireless communications, and more specifically to supporting sidelink (SL) channel occupancy time (COT) sharing between user equipments (UEs).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

Some wireless communications systems support COT sharing between a user equipment (UE) and a base station. Such COT sharing allows a UE or base station to acquire a COT and share the COT with the other of the UE and the base station.

### SUMMARY

The present disclosure relates to methods, apparatuses, and systems that support indicating sidelink channel occupancy time sharing between user equipment. A UE can acquire a COT for part of an unlicensed spectrum allowing the acquiring UE to transmit SL control and data information to a secondary UE, and furthermore share the COT with the secondary UE, allowing the secondary UE to transmit SL control and data to the acquiring UE or another UE. To initiate COT sharing, the UE that acquires the COT transmits a COT sharing indicator to one or more destination identifiers (IDs), notifying one or more secondary UEs of the COT sharing. The COT sharing indicator may include any of various information, such as remaining channel occupancy (CO) duration, priority, one or more destination IDs, offset indicating when the COT sharing may be transmitted, one or more resource pool IDs, and so forth. By utilizing the described techniques, a UE is able to notify other UEs of the COT sharing and allow those other UEs to transmit, to the acquiring UE or another UE, during the remaining CO duration.

Some implementations of the method and apparatuses described herein may include wireless communication at a device (e.g., a UE), and the apparatus receives first control signaling indicating a set of SL occasions of a resource pool, each of one or more SL associations of the set of SL occasions for monitoring a sidelink channel for sidelink control information (SCI); and transmits, to a second apparatus, second control signaling, during at least one of the set of sidelink occasions and, based at least in part on a destination identifier associated with the second apparatus, the second control signaling indicating that the apparatus is offering to share with the second apparatus a channel occupancy time (COT) acquired by the apparatus, wherein the second control signaling corresponds to at least one cast type signaling.

In some implementations of the method and apparatuses described herein, the apparatus transmits, to the second apparatus, a second control signaling indicating a time offset information identifying a start of a duration of the COT being shared. Additionally or alternatively, the apparatus transmits, to the second apparatus during an indicated SL occasion, a second control signaling indicating one or more of destination IDs, cast type, COT duration, or resource pool IDs associated with the COT sharing. Additionally or alternatively, the apparatus transmits, to the second apparatus, a medium access control (MAC) control element (CE) including one or more of destination IDs, cast type, COT duration, or resource pool IDs associated with the COT sharing. Additionally or alternatively, the apparatus transmits, to the second apparatus, the first control signaling in each subchannel, each interlaced subchannel, or each interlaced physical resource block (PRB) to the second apparatus. Additionally or alternatively, the apparatus transmits, to the second apparatus, the first control signaling indicating an intention of the apparatus to perform COT; and transmits, to the second apparatus, a second control signaling indicating a starting of sharing a remaining duration of the COT. Additionally or alternatively, the apparatus transmits the second control signaling at an end of a last transport block transmission during the COT. Additionally or alternatively, the apparatus, using time division multiplexing (TDM) transmits, to the second apparatus, the first control signaling indicating that the apparatus is sharing the COT with the second apparatus and further indicating a first channel occupancy for the second apparatus; and transmits, to a third apparatus, a second control signaling indicating that the apparatus is sharing the COT with the third apparatus and further indicating a second channel occupancy for the third apparatus. Additionally or alternatively, the apparatus receives, from a UE, a third control signaling indicating that the UE is nominating the UE as a candidate to be the second apparatus for receiving the second control signaling. Additionally or alternatively, the apparatus defines a channel occupancy (CO) duration for the COT based at least in part on at least one of a channel access priority class value, or lack of SL slots due to downlink (DL) slots, uplink (UL) slots, an UL/SL prioritization, or a resource pool boundary. Additionally or alternatively, the apparatus to restrict sharing the COT based at least in part on at least one of a cast type or a physical sidelink feedback channel (PSFCH) feedback option. Additionally or alternatively, the apparatus receives the first control signaling from a base station. Additionally or alternatively, the apparatus receives the first control signaling from a local storage.

Some implementations of the method and apparatuses described herein may include wireless communication at a device (e.g., a UE), and the apparatus receives, from a first UE during a SL occasion of a resource pool, SCI including a first control signaling indicating that the first UE is offering to share with the apparatus a COT acquired by the first UE; and transmits, to the first UE or an additional UE using the COT, a second control signaling or data or combination thereof.

In some implementations of the method and apparatuses described herein, the apparatus receives, from the first UE, the first control signaling indicating an intention of the apparatus to perform COT; and receives, from the first UE, a second control signaling indicating a starting of sharing a remaining duration of the COT. Additionally or alternatively, the apparatus transmits, to the first UE, a third control signaling indicating that the apparatus is nominating the apparatus as a candidate for receiving the first control signaling.

### BRIEF DESCRIPTION OF THE DRAWINGS

Various aspects of the present disclosure for indicating sidelink channel occupancy time sharing between user equipment are described with reference to the following Figures. The same numbers may be used throughout to reference like features and components shown in the Figures.

FIG. 1 illustrates an example of a wireless communications system that supports indicating sidelink channel occupancy time sharing between user equipment in accordance with aspects of the present disclosure.

FIG. 2 illustrates a system that supports indicating sidelink channel occupancy time sharing between user equipment in accordance with aspects of the present disclosure.

FIG. 3 illustrates an example COT duration.

FIG. 4 illustrates an example of subchannels.

FIG. 5 illustrates an example of COT sharing using TDM.

FIG. 6 illustrates an example of a block diagram of a device that supports indicating sidelink channel occupancy time sharing between user equipment in accordance with aspects of the present disclosure.

FIG. 7 illustrates an example of a block diagram of a device that supports indicating sidelink channel occupancy time sharing between user equipment in accordance with aspects of the present disclosure.

FIGS. 8, 9, 10, 11, and 12 illustrate flowcharts of methods that support indicating sidelink channel occupancy time sharing between user equipment in accordance with aspects of the present disclosure.

### DETAILED DESCRIPTION

Implementations of indicating sidelink channel occupancy time sharing between user equipment are described, such as related to a UE acquiring a COT for part of an unlicensed spectrum allowing the acquiring UE to transmit SL control and data information to a secondary UE. The acquiring UE can share the COT with the secondary UE, which refers to the acquiring UE allowing the secondary UE to use a portion of the COT to transmit SL control and data information. For example, if the acquiring UE is not using the entire COT duration to transmit control or data information, allowing the secondary UE to transmit SL control and data to the acquiring UE or another UE during part of the COT.

To initiate COT sharing, the UE that acquires the COT transmits a COT sharing indicator to one or more destination IDs, notifying one or more secondary UEs of the COT sharing. The COT sharing indicator is an indication to the one or more secondary UEs that the UE that acquired the COT is willing to allow the one or more secondary UEs to use the COT (e.g., a remaining duration of the CO that the UE that acquired the COT is not going to use to transmit control or data information). The COT sharing indicator may include any of various information, such as remaining CO duration (e.g., in terms of slots or milliseconds (ms)). Additionally or alternatively, the COT sharing indicator may include a priority, such as a channel access priority class (CAPC). Additionally or alternatively, the COT sharing indicator may include one or more destination IDs (e.g., associated with one or more UEs) for sharing the remaining CO duration. Additionally or alternatively, the COT sharing indicator may include a time slot offset or symbol offset indicating when the COT sharing indicator may be transmitted and remaining CO duration may be utilized by other neighboring (e.g., secondary) UEs for their transmission. Additionally or alternatively, the CO sharing indicator may include one or more resource pool IDs or an indicator (e.g., bitmap) containing multiple resource pool IDs.

By utilizing the described techniques, a UE is able to notify other UEs that the UE has acquired and is sharing a COT, allowing those other UEs to transmit (e.g., to the acquiring UE or another UE) during a portion of the CO (e.g., a remaining CO duration). The acquiring UE performs clear channel assessment (CCA), such as listen before talk (LBT), to establish that the channel is vacant before transmitting on the channel during the COT. However, once shared, the other UEs with which the COT is shared need not perform CCA (or may perform CCA in a reduced amount of time), allowing the other UEs to use the channel (e.g., to respond to the acquiring UE) with there being little to no chance of another UE with which the COT is not shared interfering with the COT (such as by performing CCA and establishing the channel is vacant during the COT).

Aspects of the present disclosure are described in the context of a wireless communications system. Aspects of the present disclosure are further illustrated and described with reference to device diagrams and flowcharts that relate to indicating sidelink channel occupancy time sharing between user equipment.

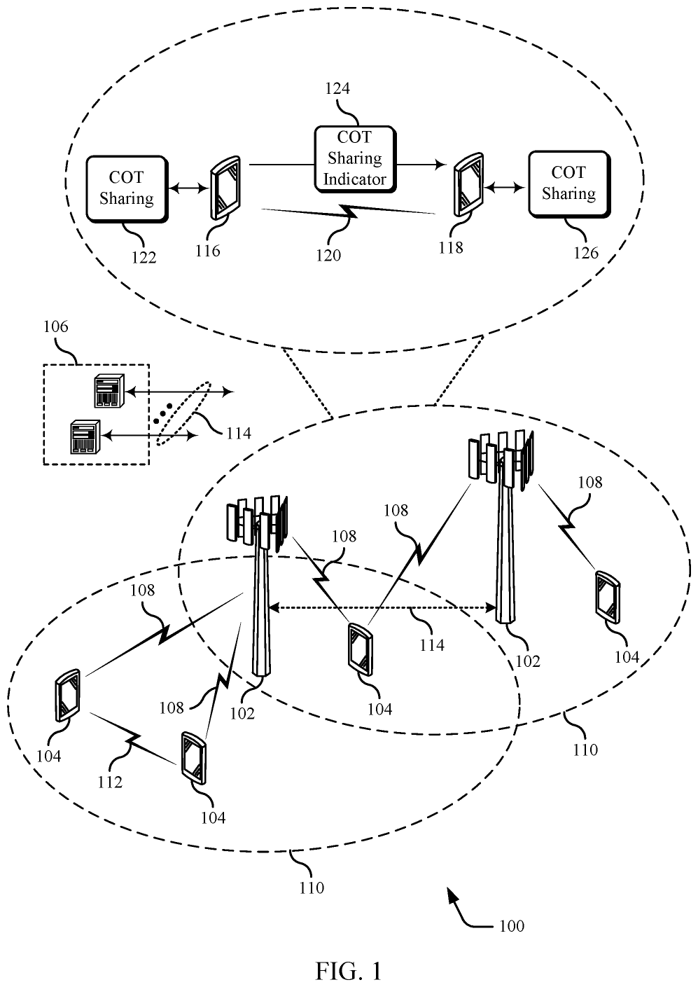

FIG. 1 illustrates an example of a wireless communications system 100 that supports indicating sidelink channel occupancy time sharing between user equipment in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (IAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, an initiating UE 116 and a secondary UE 118 can communicate with one another over a SL 120. Each of the initiating UE 116 and the secondary UE 118 is, for example, a UE 104 as discussed herein. The initiating UE 116 acquires a COT (e.g., in an unlicensed spectrum), such as from a base station 102. The initiating UE 116 performs COT sharing 122 by transmitting a COT sharing indicator 124 that is received by the secondary UE 118. The COT sharing indicator 124 notifies the secondary UE 118 that the initiating UE 116 is willing or offering to share the acquired COT. The secondary UE 118 performs COT sharing 126 to use at least part of the remaining CO duration in the COT shared by the initiating UE 116. The secondary UE 118 can use the at least part of the remaining CO duration to transmit control and data information to the initiating UE 116 or another UE 104.

In aspects of, channel access priority class (CAPC) is used. Table 1 includes example CAPC, where p refers to a CAPC, mₚ refers to a number of backoff stages for a given priority class p, CW_{min,p} refers to a minimum contention window for a given priority class p, CW_{max,p} refers to a maximum contention window for a given priority class p, T_{mcot,p} refers to a maximum channel occupancy time (MCOT) for a given priority class p, and cwₚ refers to a contention window for a given priority class p.

TABLE 1
Channel Access Priority Class (CAPC)

| Channel | | | | | |
|---|---|---|---|---|---|
| Access Priority | | | | | |
| Class (p) | mₚ | CW_{min, p} | CW_{max, p} | T_{mcot, p} | allowed cwₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, 255, 511, 1023} |

The UEs 104, including initiating UE 116 and secondary UE 118, are configured to monitor a set of SL occasions (e.g., one or more occasions) of a resource pool for a COT sharing indicator (e.g., a particular COT sharing SCI format). The SL occasions which may include a COT sharing indicator may be preconfigured (e.g., maintained in local memory of the UE) per resource pool or may be configured per resource pool from control information received from the base station 102. The UEs 104 may be configured to monitor for the COT sharing indicator in every x logical SL slots in a resource pool or in every x physical SL slots. In one or more implementations, COT sharing SCI monitoring is restricted to a resource pool or subchannels in a resource pool. Additionally or alternatively, the COT sharing indicator is transmitted in a lowest subchannel associated with a LBT subband, where the lowest subchannel can be associated with a particular resource pool in which case the UE can be preconfigured to monitor the resource pool or subchannel in a resource for monitoring COT sharing indicator.

LBT sub-bands to resource pool(s) mapping may be preconfigured (e.g., maintained in local memory of the UE) or configured from control information received from the base station 102 (e.g., in a radio resource control (RRC) common signalling). In one or more implementations, the resource pool can be frequency division multiplexed (FDM′d) and/or time division multiplexed (TDM′d) where the resource pool period contains the bitmap of slots and periods, so all FDM′d resource pools which fall under the frequency of the LBT subbands are part of the LBT subbands.

SL configured grant resources may be preconfigured (e.g., maintained in local memory of the UE) or configured from control information received from the base station 102 to sidelink UEs whose resources may be FDM′d by allocating it across resource pools.

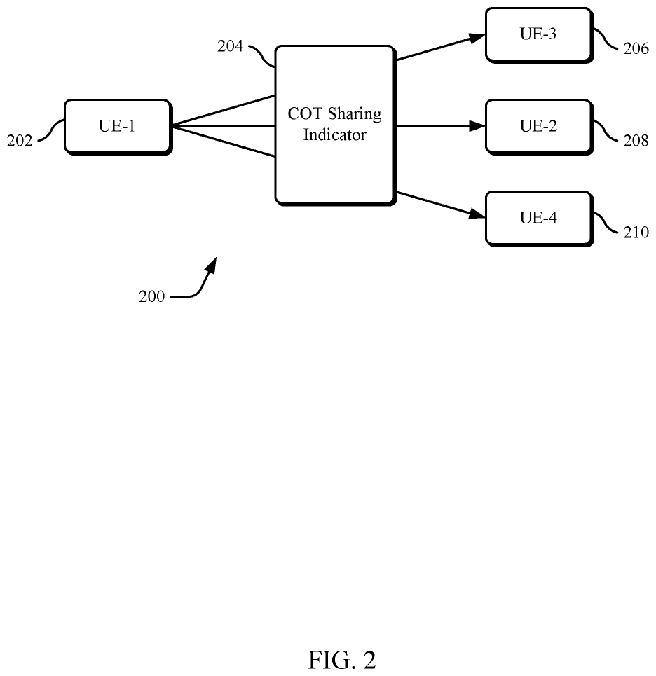

FIG. 2 illustrates a system 200 that supports indicating sidelink channel occupancy time sharing between user equipment in accordance with aspects of the present disclosure. The system 200 may use the wireless communications system 100 and/or be implemented with the wireless communications system. The system 200 includes an initiating UE 202, which is a UE 104 of FIG. 1 that is referred to as an initiating UE because the UE 202 initiates COT sharing with one or more other UEs, which are also referred to as secondary UEs. The initiating UE 202 acquires a COT (e.g., in an unlicensed spectrum), such as from a base station 102. The initiating UE 202, after performing Cat 4 LBT, performs COT sharing by transmitting one or more COT sharing indicators to one or more secondary UEs. In the illustrated example of system 200, the UE 202 transmits a COT sharing indicator 204 to a secondary UE 206, a secondary UE 208, and a secondary UE 210. Although three secondary UEs are illustrated in the system 200, it should be noted that the COT sharing indicator 204 may be transmitted to any number of secondary UEs. Although illustrated as the same COT sharing indicator 204 being transmitted to the secondary UEs 206, 208, and 210, additionally or alternatively separate COT sharing indicators 204 may be transmitted each to an individual one of the secondary UEs 206, 208, or 210.

The COT sharing indicator 204 is included in one or more of a set of SL occasions, which refer to times or locations where the COT sharing indicator 204 (if being transmitted) is expected to be received by the secondary UEs 206, 208, or 210. These SL occasions may be, for example, the physical sidelink control channel (PSCCH) in each time slot of each subchannel of the physical sidelink shared channel (PSSCH).

In one or more implementations, the initiating UE 202 notifies the secondary UEs 206, 208, or 210 of a remaining duration of the CO that is being shared. The secondary UEs 206, 208, or 210 can then use at least part of the remaining CO duration to transmit control or data information, or a combination thereof, to the initiating UE 202, to another UE (e.g., another one of the secondary UEs 206, 208, or 210), and so forth.

The COT sharing indicator 204 may be transmitted using any of a variety of types of control signaling, such as at least one of RRC, SCI, MAC CE, or the like. Similarly, other control signaling discussed herein between two or more of the UEs may also be transmitted using any of a variety of types of control signaling, such as at least one of RRC, SCI, MAC CE, or the like.

In one or more implementations, the initiating UE 202 initiates COT sharing using a single COT sharing indicator 204. The COT sharing indicator 204 may include a remaining CO duration (e.g., in terms of time slots or ms). The remaining CO duration is, for example, the duration of the COT that the initiating UE 202 is not using (e.g., for SL transmission to one of the secondary UEs 206, 208, or 210) or for UL to a base station 102.

Additionally or alternatively, the COT sharing indicator 204 includes a priority for the COT being shared (e.g., the CAPC value for the COT being shared). This allows information regarding the COT to be shared (e.g., information as discussed above with reference to Table 1), allows different COTs to be given priority over other COTs based on the priority value, and so forth.

Additionally or alternatively, the COT sharing indicator 204 includes one or more destination ID(s) for sharing the remaining CO duration. The one or more destination ID(s) identify the entities (e.g., secondary UEs) that are able to use the shared COT. The entities identified by the one or more destination ID(s) may be UEs, users or user accounts, applications and so forth. Additionally, the most significant bit (MSB) bits which may commonly represent the destination IDs from the one or more destination IDs and then the least significant bit (LSB) bits representing each destination ID are also included in the MAC CE or in SCI field, or combination thereof.

Additionally or alternatively, the COT sharing indicator 204 includes a time slot offset or symbol offset indicating when the COT sharing indicator may be transmitted and remaining CO duration may be utilized by a secondary UE for transmission by the second UE beginning from the reception of the COT sharing indicator 204.

Additionally or alternatively, the COT sharing indicator 204 includes one or more resource pool IDs or a bitmap containing multiple resource pool IDs that identify one or more resources being shared as part of the COT sharing.

The COT sharing indicator 204 may be transmitted by the initiating UE 202 in any of a variety of different manners, such as transmitted in at least one cast type signaling (e.g., groupcast or broadcast) while scheduling PSSCH with similar cast type. Accordingly, the content of the new COT sharing indicator 204 may also include fields from SCI format 2A or 2B or 2C.

In one or more implementations, the initiating UE 202 transmits (e.g., in the COT sharing indicator 204) a COT sharing SCI ‘X’ time offset so that secondary UE 206, 208, or 210 that receives the COT sharing SCI ‘X’ time offset has sufficient processing time to start its transmission (e.g., PSSCH/PSCCH/PSFCH) in the remaining CO duration. The COT sharing SCI may indicate a time slot offset or a symbol offset (X). The remaining CO duration may be defined, for example, in a number of slots, starting from the slot where the secondary UE 206, 208, or 210 detects the COT sharing SCI. The remaining CO duration may be defined, for example, in terms of physical slot duration.

In one or more implementations, the initiating UE 202 may transmit multiple (‘N’) COT sharing indicators 204 separately to each destination ID with which the initiating UE 202 would like to COT share. Such a COT sharing indicator 204 may mention remaining CO duration from the MCOT or may use a UE specific time offset (or destination ID specific offset) for starting the UE specific CO duration (or destination ID specific duration).

In one or more implementations, the COT sharing indicator 204 indicating an intent to share the COT is transmitted using SCI and additional information, such as one or more destination IDs, a time offset, and so forth is transmitted using a different type of control signaling (e.g., MAC CE). In this situation, the MAC CE (or other type of control signaling) and the SCI may be transmitted together in the same slot.

Additionally or alternatively, the initiating UE 102 initiates COT based on Cat 4 LBT, and MCOT of the initiating UE 102 is spread across multiple time domain and frequency domain resource pool(s) within the LBT subband for which the Cat 4 was successful. In such situations, the initiating UE 102 may include the resource pool ID(s) as part of the COT sharing indicator 204.

In one or more implementations, the initiating UE 102 transmits the COT sharing indicator 204 in multiple parts, such as a first part indicating the intention of the initiating UE 102 to share the COT, followed by a second part to trigger the start of sharing the remaining CO duration.

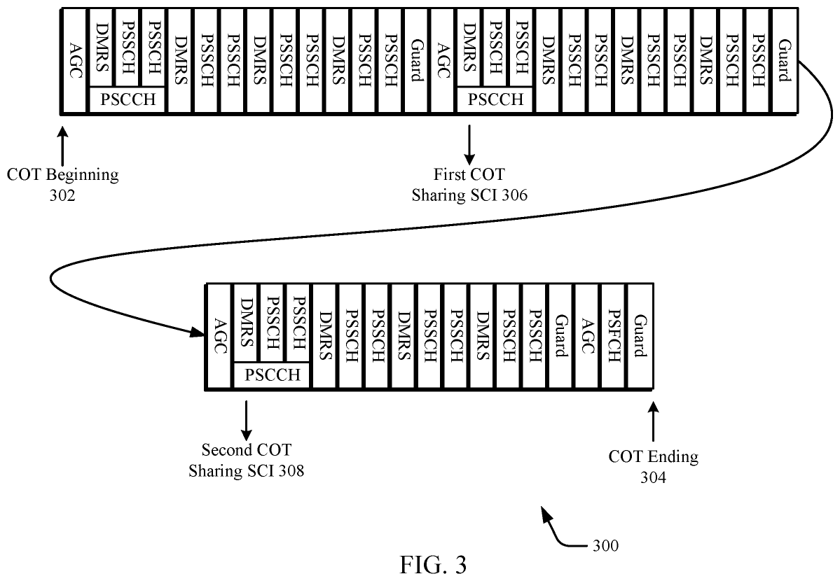

FIG. 3 illustrates an example COT duration 300. The COT duration begins (the COT is initiated) at 302 and ends at 304. The initiating UE 102 transmits a first COT sharing control signaling (e.g., a first SCI) 306 to indicate the intention to the receiving UEs or destination ID(s) for COT. The first COT sharing control signaling is included, for example, in a PSCCH. The initiating UE 102 subsequently transmits a second COT sharing control signaling (e.g., a second SCI) 308 to indicate the starting of sharing the remaining CO duration. The second COT sharing control signaling is included, for example, in a PSCCH. The remaining CO duration may be calculated by the secondary UE, for example, from the slot where the secondary UE detects the second SCI.

Additionally or alternatively, the initiating UE 102 may transmit multiple (‘N’) second COT sharing indicators 204 separately to each of one or more destination IDs with which the initiating UE 102 would like to COT share using a UE specific time offset (or destination ID specific offset) for starting the UE specific CO duration (or destination ID specific duration)

Additionally or alternatively, the second SCI may be transmitted by the initiating UE 102 at the end of its last transport block transmission within the COT.

Additionally or alternatively, the first SCI may be transmitted using broadcast or groupcast signalling while the second SCI may be transmitted using unicast or groupcast or broadcast signalling.

Additionally or alternatively, the initiating UE 102 may transmit the COT sharing indicator 204 by transmitting multiple SCI in each subchannel or interlaced subchannel or interlaced PRB to each of the one or more destination IDs and the secondary UEs, after receiving the COT sharing indicator 204, may start transmitting in the same subchannel in which the secondary UE received the COT sharing indicator 204.

It should be noted that the two SCIs for COT sharing are different from the two stage SCI design defined in NR SL, and these two SCIs are transmitted in different time slots to indicate the intention of COT sharing and actual COT sharing information.

Returning to FIG. 2, in one or more implementations, after receiving the COT sharing indicator 204 (e.g., by decoding SCI from the initiating UE 202), a secondary UE 206, 208, or 210 may start transmission from its distinctly provided configured grant (CG) resources which may be preconfigured (e.g., stored locally) or configured from control information received from a base station 102. In this case, the COT sharing indicator 204 may implicitly activate the CG resource for transmission. For example, the reception of SCI in a subchannel may implicitly activate the CG resource preconfigured or configured in that subchannel for transmission.

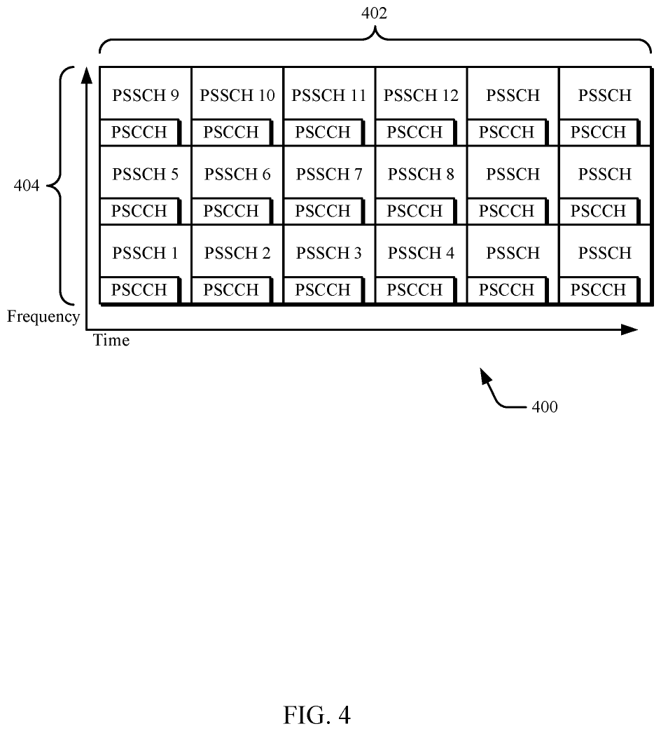

FIG. 4 illustrates an example 400 of subchannels. The example 400 shows multiple (e.g., six as illustrated) time slots 402 in each of multiple (e.g., three as illustrated) different subchannels 404. The COT sharing indicator 204 is included in the PSCCH in each time slot 402 of each subchannel 404. The secondary UEs 206, 208, or 210 monitor this PSCCH, which may be referred to as SL occasions, in order to receive the COT sharing indicator 204.

Returning to FIG. 2, in one or more implementations a secondary UE 206, 208, or 210 nominates itself as a candidate secondary UE or destination ID for receiving the COT sharing indication 204. For example, a secondary UE 206, 208, or 210 may desire to transmit SL data or PSFCH in the remaining CO duration.

To nominate itself, the secondary UE 206, 208, or 210 transmits a nomination indicator to the initiating UE 202 to request the COT sharing indicator 204. For example, a secondary UE 206, 208, or 210 may nominate itself as one of the candidate secondary UEs 206, 208, or 210 for the reception of the COT sharing indicator 204 by transmitting a nomination indicator in a L1 signalling using short control signalling exemption or using Cat 2 LBT when transmitted within the shared COT, e.g., PSFCH or SCI.

Additionally or alternatively, the secondary UE 206, 208, or 210 may transmit additional information such as buffer status, requested minimum and maximum time slot duration, and so forth that might help the initiating UE 202 to determine sharing remaining COT duration to the secondary UE 206, 208, or 210.

In one or more implementations, the end of the remaining channel occupancy duration by the initiating UE 202 or by the secondary UE 206, 208, or 210 after receiving the COT sharing indicator 204 may be defined according to the maximum MCOT duration defined according to the corresponding CAPC priority value. Additionally or alternatively, when there is no PSSCH/PSFCH transmission then the COT may end early. Additionally or alternatively, the COT may end early due to slot format indicator (SFI) where absence of SL slots due to DL and UL slots or symbols or due to UL or SL prioritization procedure in the same/different frequency.

In one or more implementations, the end of the remaining channel occupancy duration by the initiating UE 202 or by the secondary UE 206, 208, or 210 after receiving the COT sharing indicator 204 may be defined at most to the remaining CO duration irrespective of the resource pool length. Additionally or alternatively, if the resource pool length is shorter than the remaining CO duration then the end of the remaining CO duration is defined according to the remaining CO duration, so the initiating UE 202 could use another resource pool that is still within the remaining CO duration. Additionally or alternatively, if the resource pool length is shorter than the remaining CO duration then the end of the remaining CO duration is defined according to the resource pool logical slot boundary (the resource pool logical slot boundary corresponding to where the COT sharing SCI was received).

In one or more implementations, the COT duration indicates a remaining length from the beginning of the slot where the information is received and when a secondary UE 206, 208, or 210 receives a COT duration indication with a given symbol being within the COT duration, the secondary UE 206, 208, or 210 is not expected to receive a subsequent COT duration indication that indicates that symbol to not be within the COT duration, so the information field between successive SCI within the COT should be same.

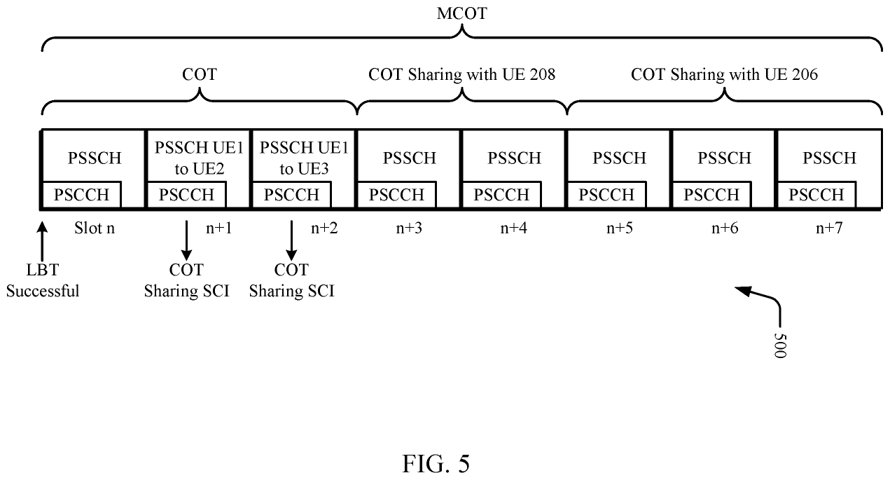

FIG. 5 illustrates an example 500 of COT sharing using time division multiplexing (TDM). The initiating UE 202 may perform Cat 4 LBT and share the COT with particular secondary UEs in a TDM manner. The COT sharing indicator 204 may indicate the limited UE specific channel occupancy duration to each secondary UE (or destination ID specific channel occupancy duration), UE specific time offset and so forth. The UE specific channel occupancy duration may be equal or less than the remaining channel occupancy duration. As shown in the example 500, the initiating UE 202 may initiate the COT and share the COT in a TDM manner to each different secondary UE 206 and 208 in a separate COT sharing SCI.

In the example 500, the COT duration is shown by MCOT. The first three slots of the COT are used by the initiating UE 202. A COT sharing indicator 204 is included in the PSCCH of slot n+1 indicating a CO duration to be shared with UE 208, which is illustrated as slots n+3 and n+4. Another COT sharing indicator 204 is included in the PSCCH of slot n+2 indicating a CO duration to be shared with UE 206, which is illustrated as slots n+5, n+6, and n+7.

Returning to FIG. 2, in one or more implementations, the UE to UE COT sharing is restricted to a certain cast type and/or PSFCH feedback options (e.g., unicast hybrid automatic repeat request (HARQ), groupcast HARQ feedback option 1 and groupcast feedback option 2) and can be configured in a resource pool and semi-statically configured by a base station 102 using RRC common signalling. For example, UE to UE COT sharing may be restricted only to unicast PSSCH/PSCCH/PSFCH and in another example, the UE to UE COT sharing maybe applicable to unicast PSSCH/PSCCH/PSFCH and groupcast PSFCH only and so forth.

In one or more implementations, UE to UE COT sharing uses the COT sharing indicator in an SCI format. The UE to UE COT sharing may signal multiple destination IDs, time offset for sharing COT with other receiving (e.g., secondary) UEs as additional information in the same SCI. The UE to UE COT sharing may signal multiple destination IDs, time offset for sharing COT with other receiving (e.g., secondary) UEs as additional information in a MAC CE while the MAC CE may be transmitted together with the COT sharing SCI. The transmit (e.g., initiating) UE may transmit the COT sharing indicator by transmitting multiple SCIs in each subchannel/interlaced subchannel/interlaced PRBs to each of the multiple destination IDs.

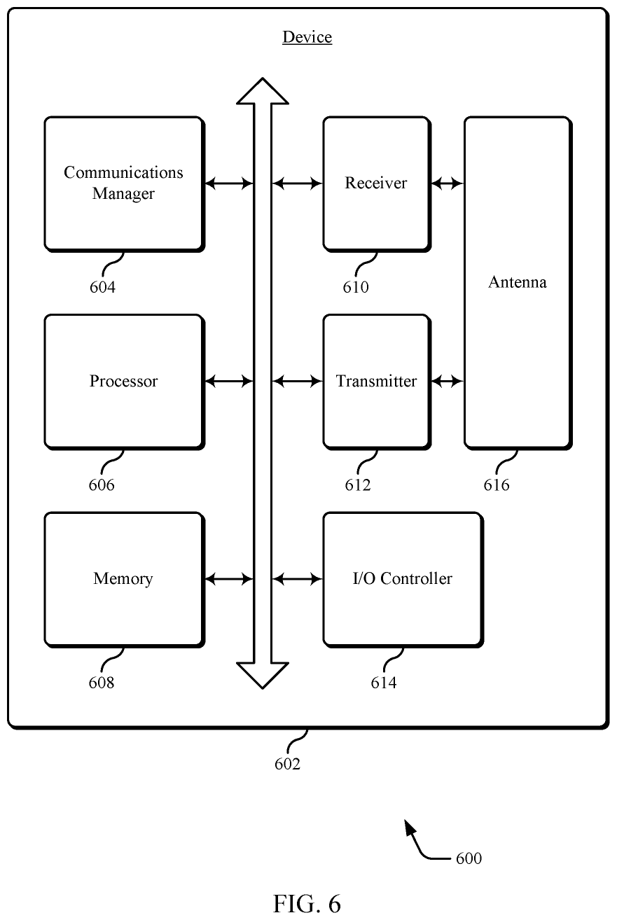

FIG. 6 illustrates an example of a block diagram 600 of a device 602 that supports indicating sidelink channel occupancy time sharing between user equipment in accordance with aspects of the present disclosure. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE, including a transceiver; a processor coupled to the transceiver, the processor and the transceiver configured to cause the apparatus to: receive first control signaling indicating a set of SL occasions of a resource pool, each of one or more SL associations of the set of SL occasions for monitoring a sidelink channel for SCI; and transmit, to a second apparatus, second control signaling, during at least one of the set of sidelink occasions and, based at least in part on a destination identifier associated with the second apparatus, the second control signaling indicating that the apparatus is offering to share with the second apparatus a COT acquired by the apparatus, where the second control signaling corresponds to at least one cast type signaling.

Additionally, the apparatus (e.g., a UE) includes any one or combination of: where the processor and the transceiver are further configured to cause the apparatus to transmit, to the second apparatus, a second control signaling indicating a time offset information identifying a start of a duration of the COT being shared; where the processor and the transceiver are further configured to cause the apparatus to transmit, to the second apparatus during an indicated SL occasion, a second control signaling indicating one or more of destination IDs, cast type, COT duration, or resource pool IDs associated with the COT sharing; where the processor and the transceiver are further configured to cause the apparatus to transmit, to the second apparatus, a MAC CE including one or more of destination IDs, cast type, COT duration, or resource pool IDs associated with the COT sharing; where the processor and the transceiver are further configured to cause the apparatus to transmit, to the second apparatus, the first control signaling in each subchannel, each interlaced subchannel, or each interlaced PRB to the second apparatus; where the processor and the transceiver are further configured to cause the apparatus to: transmit, to the second apparatus, the first control signaling indicating an intention of the apparatus to perform COT; and transmit, to the second apparatus, a second control signaling indicating a starting of sharing a remaining duration of the COT; where the processor and the transceiver are further configured to cause the apparatus to transmit the second control signaling at an end of a last transport block transmission during the COT; where the processor and the transceiver are further configured to cause the apparatus to, using TDM: transmit, to the second apparatus, the first control signaling indicating that the apparatus is sharing the COT with the second apparatus and further indicating a first channel occupancy for the second apparatus; and transmit, to a third apparatus, a second control signaling indicating that the apparatus is sharing the COT with the third apparatus and further indicating a second channel occupancy for the third apparatus; where the processor and the transceiver are further configured to cause the apparatus to receive, from a UE, a third control signaling indicating that the UE is nominating the UE as a candidate to be the second apparatus for receiving the second control signaling; where the processor and the transceiver are further configured to cause the apparatus to define a CO duration for the COT based at least in part on at least one of a channel access priority class value, or lack of SL slots due to DL slots, UL slots, an UL/SL prioritization, or a resource pool boundary; where the processor and the transceiver are further configured to cause the apparatus to restrict sharing the COT based at least in part on at least one of a cast type or a PSFCH feedback option; where the processor and the transceiver are further configured to cause the apparatus to receive the first control signaling from a base station; where the processor and the transceiver are further configured to cause the apparatus to receive the first control signaling from a local storage.

Additionally or alternatively, the communications manager 604 and/or other device components may be configured as or otherwise support an apparatus, such as a UE, including a transceiver; a processor coupled to the transceiver, the processor and the transceiver configured to cause the apparatus to: receive, from a first UE during a SL occasion of a resource pool, SCI including a first control signaling indicating that the first UE is offering to share with the apparatus a COT acquired by the first UE; and transmit, to the first UE or an additional UE using the COT, a second control signaling or data or combination thereof.

Additionally, the apparatus (e.g., a UE) includes any one or combination of: where the processor and the transceiver are further configured to cause the apparatus to: receive, from the first UE, the first control signaling indicating an intention of the apparatus to perform COT; and receive, from the first UE, a second control signaling indicating a starting of sharing a remaining duration of the COT; where the processor and the transceiver are further configured to cause the apparatus to transmit, to the first UE, a third control signaling indicating that the apparatus is nominating the apparatus as a candidate for receiving the first control signaling.

The communications manager 604 and/or other device components may be configured as or otherwise support a means for wireless communication and/or network signaling at a UE, including receiving first control signaling indicating a set of SL occasions of a resource pool, each of one or more SL associations of the set of SL occasions for monitoring a sidelink channel for SCI; and transmitting, to a second UE, second control signaling, during at least one of the set of sidelink occasions and, based at least in part on a destination identifier associated with the second UE, the second control signaling indicating that the UE is offering to share with the second UE a COT acquired by the UE, where the second control signaling corresponds to at least one cast type signaling.

Additionally, wireless communication and/or network signaling at the UE includes any one or combination of: transmitting, to the second UE, a second control signaling indicating a time offset information identifying a start of a duration of the COT being shared; transmitting, to the second UE during an indicated SL occasion, a second control signaling indicating one or more of destination IDs, cast type, COT duration, or resource pool IDs associated with the COT sharing; transmitting, to the second UE, a MAC CE including one or more of destination IDs, cast type, COT duration, or resource pool IDs associated with the COT sharing; transmitting, to the second UE, the first control signaling in each subchannel, each interlaced subchannel, or each interlaced PRB to the second UE; transmitting, to the second UE, the first control signaling indicating an intention of the UE to perform COT; and transmitting, to the second UE, a second control signaling indicating a starting of sharing a remaining duration of the COT; transmitting the second control signaling at an end of a last transport block transmission during the COT; using TDM: transmitting, to the second UE, the first control signaling indicating that the UE is sharing the COT with the second UE and further indicating a first channel occupancy for the second UE; and transmitting, to a third UE, a second control signaling indicating that the UE is sharing the COT with the third UE and further indicating a second channel occupancy for the second third UE; receiving, from a third UE, a third control signaling indicating that the third UE is nominating the third UE as a candidate to be the second UE for receiving the second control signaling; defining a CO duration for the COT based at least in part on at least one of a channel access priority class value, or lack of SL slots due to DL slots, UL slots, a UL/SL prioritization, or a resource pool boundary; restricting sharing the COT based at least in part on at least one of a cast type or a PSFCH feedback option; receiving the first control signaling from a base station; receiving the first control signaling from a local storage.

The communications manager 604 and/or other device components may be configured as or otherwise support a means for wireless communication and/or network signaling at a UE, including receiving, from a second UE during a SL occasion of a resource pool, SCI including a first control signaling indicating that the second UE is offering to share with the first UE a COT acquired by the second UE; and transmitting, to the second UE or a third UE using the COT, a second control signaling or data or combination thereof.

Additionally, wireless communication and/or network signaling at the UE includes any one or combination of: receiving, from the second UE, the first control signaling indicating an intention of the second UE to perform COT; and receiving, from the second UE, a second control signaling indicating a starting of sharing a remaining duration of the COT; transmitting, to the second UE, a third control signaling indicating that the first UE is nominating the first UE as a candidate for receiving the first control signaling.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

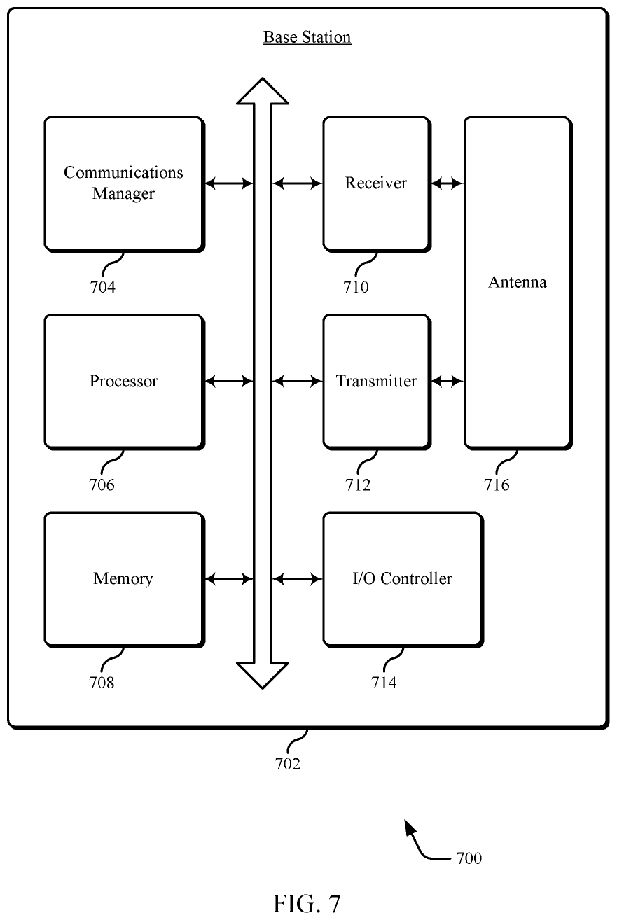

FIG. 7 illustrates an example of a block diagram 700 of a device 702 that supports indicating sidelink channel occupancy time sharing between user equipment in accordance with aspects of the present disclosure. The device 702 may be an example of a base station 102, such as a gNB as described herein. The device 702 may support wireless communication and/or network signaling with one or more base stations 102, other UEs 104, core network devices and functions (e.g., core network 106), or any combination thereof. The device 702 may include components for bi-directional communications including components for transmitting and receiving communications, such as a communications manager 704, a processor 706, a memory 708, a receiver 710, a transmitter 712, and an I/O controller 714. These components may be in electronic communication or otherwise coupled (e.g., operatively, communicatively, functionally, electronically, electrically) via one or more interfaces (e.g., buses).

The communications manager 704, the receiver 710, the transmitter 712, or various combinations thereof or various components thereof may be examples of means for performing various aspects of the present disclosure as described herein. For example, the communications manager 704, the receiver 710, the transmitter 712, or various combinations or components thereof may support a method for performing one or more of the functions described herein.

In some implementations, the communications manager 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally or alternatively, in some implementations, the communications manager 704, the receiver 710, the transmitter 712, or various combinations or components thereof may be implemented in code (e.g., as communications management software or firmware) executed by the processor 706. If implemented in code executed by the processor 706, the functions of the communications manager 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 704 may be configured to perform various operations (e.g., receiving, monitoring, transmitting) using or otherwise in cooperation with the receiver 710, the transmitter 712, or both. For example, the communications manager 704 may receive information from the receiver 710, send information to the transmitter 712, or be integrated in combination with the receiver 710, the transmitter 712, or both to receive information, transmit information, or perform various other operations as described herein. Although the communications manager 704 is illustrated as a separate component, in some implementations, one or more functions described with reference to the communications manager 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the communications manager 704 may support wireless communication and/or network signaling at a device (e.g., the device 702, a base station) in accordance with examples as disclosed herein.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

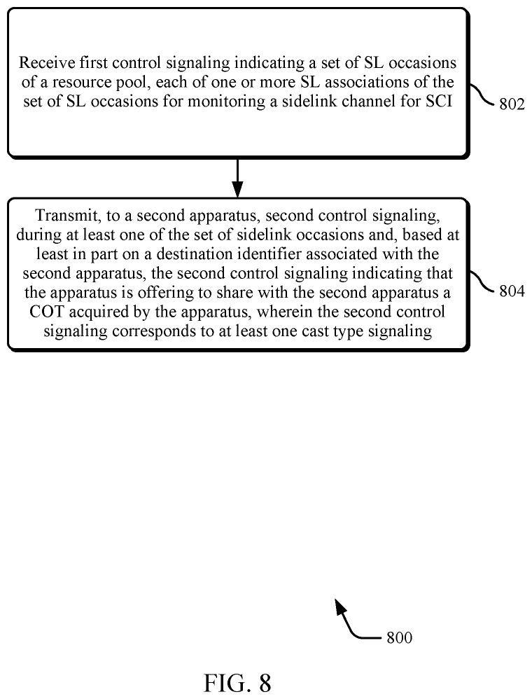

FIG. 8 illustrates a flowchart of a method 800 that supports indicating sidelink channel occupancy time sharing between user equipment in accordance with aspects of the present disclosure. The operations of the method 800 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include receiving first control signaling indicating a set of SL occasions of a resource pool, each of one or more SL associations of the set of SL occasions for monitoring a sidelink channel for SCI. The operations of 802 may be performed in accordance with examples as described herein. In some implementations, aspects of the operations of 802 may be performed by a device as described with reference to FIG. 1 or FIG. 2.

At 804, the method may include transmitting, to a second apparatus, second control signaling, during at least one of the set of sidelink occasions and, based at least in part on a destination identifier associated with the second apparatus, the second control signaling indicating that the apparatus is offering to share with the second apparatus a COT acquired by the apparatus, wherein the second control signaling corresponds to at least one cast type signaling. The operations of 804 may be performed in accordance with examples as described herein. In some implementations, aspects of the operations of 804 may be performed by a device as described with reference to FIG. 1 or FIG. 2.

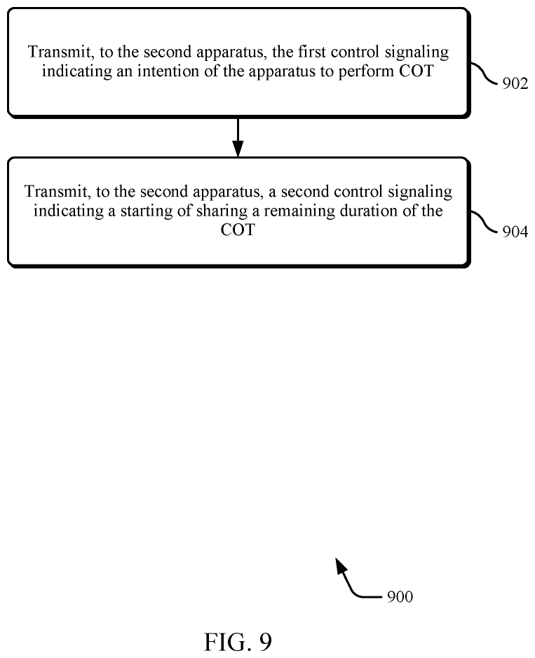

FIG. 9 illustrates a flowchart of a method 900 that supports indicating sidelink channel occupancy time sharing between user equipment in accordance with aspects of the present disclosure. The operations of the method 900 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include transmitting, to the second apparatus, the first control signaling indicating an intention of the apparatus to perform COT. The operations of 902 may be performed in accordance with examples as described herein. In some implementations, aspects of the operations of 902 may be performed by a device as described with reference to FIG. 1 or FIG. 2.

At 904, the method may include transmitting, to the second apparatus, a second control signaling indicating a starting of sharing a remaining duration of the COT. The operations of 904 may be performed in accordance with examples as described herein. In some implementations, aspects of the operations of 904 may be performed by a device as described with reference to FIG. 1 or FIG. 2.

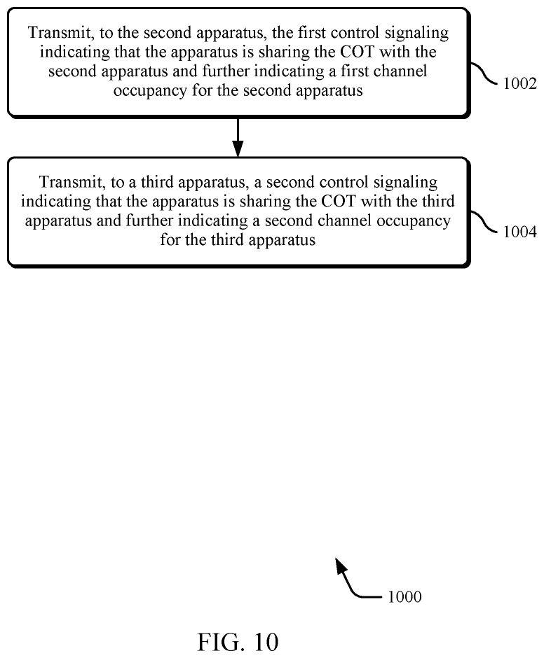

FIG. 10 illustrates a flowchart of a method 1000 that supports indicating sidelink channel occupancy time sharing between user equipment in accordance with aspects of the present disclosure. The operations of the method 1000 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include transmitting, to the second apparatus, the first control signaling indicating that the apparatus is sharing the COT with the second apparatus and further indicating a first channel occupancy for the second apparatus. The operations of 1002 may be performed in accordance with examples as described herein. In some implementations, aspects of the operations of 1002 may be performed by a device as described with reference to FIG. 1 or FIG. 2.

At 1004, the method may include transmitting, to a third apparatus, a second control signaling indicating that the apparatus is sharing the COT with the third apparatus and further indicating a second channel occupancy for the third apparatus. The operations of 1004 may be performed in accordance with examples as described herein. In some implementations, aspects of the operations of 1004 may be performed by a device as described with reference to FIG. 1 or FIG. 2.

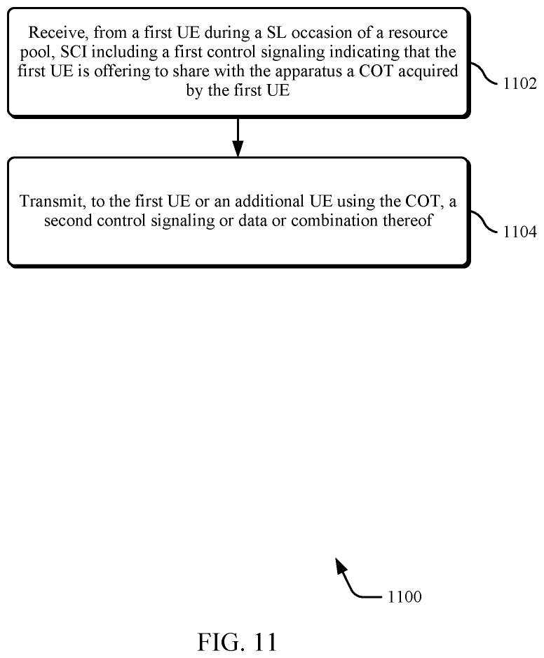

FIG. 11 illustrates a flowchart of a method 1100 that supports indicating sidelink channel occupancy time sharing between user equipment in accordance with aspects of the present disclosure. The operations of the method 1100 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1102, the method may include receiving, from a first UE during a SL occasion of a resource pool, SCI including a first control signaling indicating that the first UE is offering to share with the apparatus a COT acquired by the first UE. The operations of 1102 may be performed in accordance with examples as described herein. In some implementations, aspects of the operations of 1102 may be performed by a device as described with reference to FIG. 1 or FIG. 2.

At 1104, the method may include transmitting, to the first UE or an additional UE using the COT, a second control signaling or data or combination thereof. The operations of 1104 may be performed in accordance with examples as described herein. In some implementations, aspects of the operations of 1104 may be performed by a device as described with reference to FIG. 1 or FIG. 2.

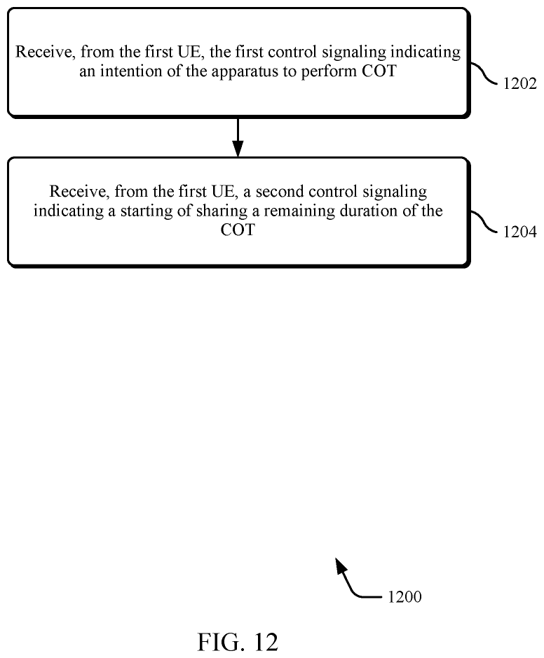

FIG. 12 illustrates a flowchart of a method 1200 that supports indicating sidelink channel occupancy time sharing between user equipment in accordance with aspects of the present disclosure. The operations of the method 1200 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1202, the method may include receiving, from the first UE, the first control signaling indicating an intention of the apparatus to perform COT. The operations of 1202 may be performed in accordance with examples as described herein. In some implementations, aspects of the operations of 1202 may be performed by a device as described with reference to FIG. 1 or FIG. 2.

At 1204, the method may include receiving, from the first UE, a second control signaling indicating a starting of sharing a remaining duration of the COT. The operations of 1204 may be performed in accordance with examples as described herein. In some implementations, aspects of the operations of 1204 may be performed by a device as described with reference to FIG. 1 or FIG. 2.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A first user equipment (UE) for wireless communications, comprising:
at least one memory; and
at least one processor coupled with the at least one memory and configured to cause the first UE to:
receive first control signaling indicating a set of sidelink (SL) occasions of a resource pool, each of one or more SL associations of the set of SL occasions for monitoring a sidelink channel for sidelink control information (SCI);
transmit, to a second UE, second control signaling, during at least one of the set of sidelink occasions and, based at least in part on a destination identifier associated with the second UE, the second control signaling indicating an intention of the first UE to perform channel occupancy time (COT) sharing and that the first UE is offering to share with the second UE a COT acquired by the first UE, wherein the second control signaling corresponds to at least one cast type signaling;
transmit, to the second UE, a third control signaling indicating a starting of sharing a remaining duration of the COT.

2. (canceled)

3. The first UE of claim 1, wherein the at least one processor is further configured to cause the first UE to transmit, to the second UE during an indicated SL occasion, a fourth control signaling indicating one or more of destination IDs, cast type, COT duration, or resource pool IDs associated with the COT sharing.

4. The first UE of claim 1, wherein the at least one processor is further configured to cause the first UE to transmit, to the second UE, a medium access control (MAC) control element (CE) including one or more of destination IDs, cast type, COT duration, or resource pool IDs associated with the COT sharing.

5. The first UE of claim 1, wherein the at least one processor is further configured to cause the first UE to transmit, to the second UE, the first second control signaling in each subchannel, each interlaced subchannel, or each interlaced physical resource block (PRB) to the second UE.

6. (canceled)

7. The first UE of claim 1, wherein the at least one processor is further configured to cause the first UE to transmit the third control signaling at an end of a last transport block transmission during the COT.

8. The first UE of claim 1, wherein the at least one processor is further configured to cause the first UE to, using time division multiplexing (TDM):
transmit, to the second UE, the second control signaling indicating that the first UE is sharing the COT with the second UE and further indicating a first channel occupancy for the second UE; and
transmit, to a third UE, a second fourth control signaling indicating that the first UE is sharing the COT with the third UE and further indicating a second channel occupancy for the third UE.

9. The first UE of claim 1, wherein the at least one processor is further configured to cause the first UE to receive, from a third UE, a fourth control signaling indicating that the third UE is nominating the third UE as a candidate to be the second UE for receiving the second control signaling.

10. The first UE of claim 1, wherein the at least one processor is further configured to cause the first UE to define a channel occupancy (CO) duration for the COT based at least in part on at least one of a channel access priority class value, or lack of SL slots due to downlink (DL) slots, uplink (UL) slots, an UL/SL prioritization, or a resource pool boundary.

11. The first UE of claim 1, wherein the at least one processor is further configured to cause the first UE to restrict sharing the COT based at least in part on at least one of a cast type or a physical sidelink feedback channel (PSFCH) feedback option.

12. The first UE of claim 1, wherein the at least one processor is further configured to cause the first UE to receive the first control signaling from a base station.

13. The first UE of claim 1, wherein the at least one processor is further configured to cause the first UE to receive the first control signaling from a local storage.

14. A first user equipment (UE) for wireless communications, comprising:
at least one memory; and
at least one processor coupled with the at least one memory and configured to cause the first UE to:
receive, from a second UE during a sidelink (SL) occasion of a resource pool, sidelink control information (SCI) including a first control signaling indicating an intention of the second UE to perform channel occupancy time (COT) sharing and that the second first UE is offering to share with the first UE a COT acquired by the second first UE; and
receive, from the second UE, a second control signaling indicating a starting of sharing a remaining duration of the COT.

15. (canceled)

16. The first UE of claim 14, wherein the at least one processor is further configured to cause the first UE to transmit, to the second UE, a third control signaling indicating that the first UE is nominating the first UE as a candidate for receiving the first control signaling.

17-20. (canceled)

21. A processor for wireless communication, comprising:
at least one controller coupled with at least one memory and configured to cause the processor to:
receive first control signaling indicating a set of sidelink (SL) occasions of a resource pool, each of one or more SL associations of the set of SL occasions for monitoring a sidelink channel for sidelink control information (SCI);
transmit, to a user equipment (UE), second control signaling, during at least one of the set of sidelink occasions and, based at least in part on a destination identifier associated with the UE, the second control signaling indicating an intention of the processor to perform channel occupancy time (COT) sharing and that the processor is offering to share with the UE a COT acquired by the processor, wherein the second control signaling corresponds to at least one cast type signaling;
transmit, to the UE, a third control signaling indicating a starting of sharing a remaining duration of the COT.

22. The processor of claim 21, wherein the at least one controller is further configured to cause the processor to transmit, to the UE during an indicated SL occasion, a fourth control signaling indicating one or more of destination IDs, cast type, COT duration, or resource pool IDs associated with the COT sharing.

23. The processor of claim 21, wherein the at least one controller is further configured to cause the processor to transmit, to the UE, a medium access control (MAC) control element (CE) including one or more of destination IDs, cast type, COT duration, or resource pool IDs associated with the COT sharing.

24. The processor of claim 21, wherein the at least one controller is further configured to cause the processor to transmit, to the UE, the second control signaling in each subchannel, each interlaced subchannel, or each interlaced physical resource block (PRB) to the UE.

25. The processor of claim 21, wherein the at least one controller is further configured to cause the processor to transmit the third control signaling at an end of a last transport block transmission during the COT.

26. A processor for wireless communication, comprising:
at least one controller coupled with at least one memory and configured to cause the processor to:
receive, from a user equipment (UE) during a sidelink (SL) occasion of a resource pool, sidelink control information (SCI) including a first control signaling indicating an intention of the UE to perform channel occupancy time (COT) sharing and that the UE is offering to share with the processor a COT acquired by the UE; and
receive, from the UE, a second control signaling indicating a starting of sharing a remaining duration of the COT.

27. The processor of claim 26, wherein the at least one controller is further configured to cause the processor to transmit, to the UE, a third control signaling indicating that the processor is nominating the processor as a candidate for receiving the first control signaling.
